(19) United States
(12) Patent Application Publication
(10) Pub. No.: US 2014/0101884 A1
(43) Pub. Date: Apr. 17, 2014

(54) BEAM BLADE WIPER ASSEMBLY AND METHOD OF ASSEMBLY

(71) Applicant: TRICO PRODUCTS CORPORATION, Rochester Hills, MI (US)

(72) Inventors: Gary Balitzkat, Fairborn, OH (US); Kyle S. Moll, Oxford, MI (US); Christopher A. Weber, Troy, MI (US)

(73) Assignee: TRICO PRODUCTS CORPORATION, Rochester Hills, MI (US)

(21) Appl. No.: 13/649,309

(22) Filed: Oct. 11, 2012

(51) Int. Cl. B60S 1/38; B23P 17/04

(52) U.S. Cl. 15/250.201; 29/428

(57) ABSTRACT

A beam blade wiper assembly includes a wiping element and at least one elongated beam. An airfoil is operatively mounted to the beam. The beam includes at least one notch and the airfoil has a portion displaced into the at least one notch to retain the airfoil to the beam.

### BACKGROUND OF THE INVENTION

1. Field of the Invention

The present invention relates, generally, to wiper assemblies for vehicles, and more specifically, to a beam blade wiper assembly and a method of assembling the beam blade wiper assembly for a vehicle.

2. Description of the Related Art

Conventional wiper assemblies for vehicles known in the related art include some type of blade wiper assembly mounted to a wiper arm which, in turn, is mounted adjacent a surface to be wiped such as a windshield of the vehicle and pivotally driven to impart reciprocal motion to the blade wiper assembly across the windshield. The blade wiper assembly includes a rubber wiping element that contacts the windshield across the surface to be wiped. The wiper assembly often incorporates one or more metal strips which act to reinforce the wiping element and facilitate wiping contact by the wiping element across what is typically a curved glass surface. In this context, the wiper arm delivers a downward force to the blade wiper assembly that is distributed thereacross pressing the blade wiper assembly into contact with the windshield. The blade wiper assemblies may also include an airfoil and a pair of end caps located at the distal ends of the blade wiper assembly.

Current state of the art beam blade strategies require the application of a plastic end cap, connecting to metal strips. In some cases, the end caps serve to retain the metal strips relative to the wiping element, as well as retain the airfoil between a coupler and the end caps. In other circumstances, the end cap may be employed to retain and position the rubber wiping element within the metal strips or may have a feature that allows the rubber wiping element to be removed making the wiping element refillable. The purpose of the end cap is to hold the pair of metal strips parallel to each other, prevent rubber element axial movement, prevent airfoil axial movement, and maintain blade wiper assembly integrity.

End caps of the aforementioned type are well known in the related art. Many end caps require a positive and secure mechanism for physically attaching the end cap to the metal strips and/or airfoil component. In order for the end caps to be assembled to either a single, monolithic beam or a pair of metal strips, the end caps typically known in the related art must be flexible such that they may be splayed open when assembled around the splines. In this context, the end cap essentially flexes outwardly and in the general plane of the monolithic beam or metal strips. Alternatively, a separate component is used as a latching mechanism to positively fix the end cap relative to the beam or splines.

Currently, if the end cap fails to function, there is an increased risk that the blade will begin to self-disassemble. This disassembly typically begins with axial movement of the airfoil (as it slides off the end of the blade wiper assembly). When the airfoil completely disengages the blade, the splines are not sufficiently positioned and the blade disassembles, becomes partially functional and there is an increased risk that the windshield may be scratched and impairs driver vision. Therefore, there is a need in the art for an effective method to preclude the airfoil from sliding off the blade wiper assembly, the risk of blade wiper disassembly, and possible windshield damage.

### SUMMARY OF THE INVENTION

The present invention overcomes the disadvantages in the related art in a beam blade wiper assembly including a wiping element adapted to contact a surface to be wiped. At least one elongated beam defines a longitudinal axis. The beam acts to support the wiping element. An airfoil is operatively mounted to the beam. The beam includes at least one notch and the airfoil has a portion displaced into the at least one notch to retain the airfoil to the beam.

The present invention is also a method of assembling a beam blade wiper assembly including the steps of providing a wiping element adapted to contact a surface to be wiped, the wiping element including opposed longitudinal ends. The method also includes the steps of providing at least one elongated beam defining a longitudinal axis and having at least one notch and supporting the wiping element with the beam. The method further includes the steps of providing an airfoil and mounting the airfoil to the beam and displacing a portion of the airfoil into the at least one notch to retain the airfoil to the beam.

In this way, the airfoil is precluded from sliding off the blade wiper assembly, thereby reducing the risk of blade wiper disassembly and possible windshield damage. In addition, the method provides improved airfoil retention in case the end cap is disengaged once it has been installed to either a monolithic beam or a pair of dual splines or rails of the blade wiper assembly.

### BRIEF DESCRIPTION OF THE DRAWINGS

Other objects, features and advantages of the present invention will be readily appreciated as the same becomes better understood after reading the subsequent description taken in connection with the accompanying drawings wherein:

FIG. 1 is a partial perspective view of a front of an automotive vehicle having a pair of blade wiper assemblies, according to one embodiment of the present invention, pivotally mounted for reciprocal movement across a windshield of the vehicle;

FIG. 2 is an enlarged perspective view of the blade wiper assembly according to one embodiment of the present invention;

FIG. 3 is an exploded perspective view of the blade wiper assembly according to one embodiment of the present invention;

FIG. 4 is a cross-sectional end view of the blade wiper assembly according to one embodiment of the present invention prior to assembly;

FIG. 5 is a cross-sectional end view of the blade wiper assembly according to one embodiment of the present invention after assembly; and

FIG. 6 is a cross-sectional end view of the end cap mounted to the blade wiper assembly according to one embodiment of the present invention.

### DETAILED DESCRIPTION OF THE PREFERRED EMBODIMENT(S)

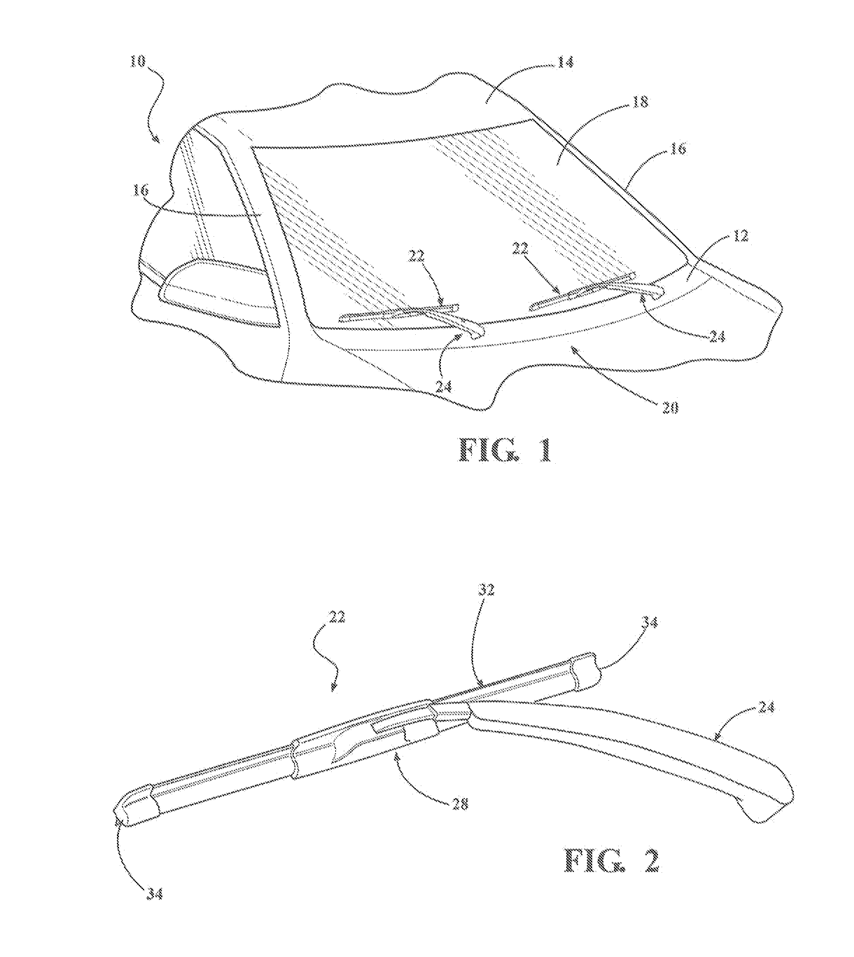

Referring now to the figures, where like numerals are used to designate like structure, a portion of a vehicle is illustrated at 10 in FIG. 1. The portion of the vehicle 10 includes a body having a cowl 12, a roof 14, and a pair of laterally spaced front or “A” pillars 16 extending between the roof 14 and the cowl 12. The A-pillars 16, roof 14, and cowl 12 cooperate to define a generally rectangular perimeter, which supports a curved or “swept back” windshield 18.

A wiper system is generally indicated at 20 in FIG. 1 and is employed to clean the windshield 18. In the representative example illustrated herein, the wiper system 20 includes a pair of blade wiper assemblies, generally indicated at 22, and which correspond to the driver and passenger side of the vehicle 10. However, those having ordinary skill in the art will appreciate that the wiper system 20 could employ a single blade wiper assembly 22 without departing from the scope of the present invention. Each blade wiper assembly 22 (hereinafter “wiper assembly”) is carried by a corresponding wiper arm assembly, generally indicated at 24. The wiper arm assembly 24 includes an attachment member (not shown but generally known in the art) adapted to operatively engage the wiper assembly 22. An electrical motor (not shown but generally known in the art) is typically employed to power the wiper system 20 to move the blade wiper assemblies 22 in an oscillating manner across the surface of the windshield 18.

While the wiper assembly 22 illustrated in FIG. 1 is shown in connection with the front windshield 18 of the vehicle 10, those having ordinary skill in the art will appreciate that wiper assemblies 22 may be employed in other areas of the vehicle 10, such as a rear window (not shown) or a head lamp (not shown) that employs a wiper system. Thus, it will be understood that the present invention is not limited for use solely in connection with wiper arm assemblies 24 and wiper assemblies 22 adapted for use on a vehicle's windshield 18, but for use in all applications where wiper arm assemblies 24 and wiper assemblies 22 are employed.

Referring to FIGS. 2-6, the wiper assembly 22 includes a wiping element, generally indicated at 26, that is adapted to contact the surface of the vehicle 10 to be wiped, in this representative example, the windshield 18. In addition, the wiper assembly 22 generally includes a coupler assembly, generally indicated at 28, that acts to interconnect the wiper arm assembly 24 and the wiping element 26. The wiper assembly 22 also includes at least one elongated beam 30 that defines a longitudinal axis and that acts to support the wiping element 26. In the representative embodiment illustrated herein, the beam 30 includes a pair of rails or splines, generally indicated at 30A, that are operatively supported in the wiping element 26. However, those having ordinary skill in the art will appreciate from the description that follows that the beam 30 may be either monolithic or defined by the pair of rails 30A. The wiper assembly 22 may also include an airfoil assembly, generally indicated at 32, and a pair of end caps, generally indicated at 34. Each of these components will be described in greater detail below.

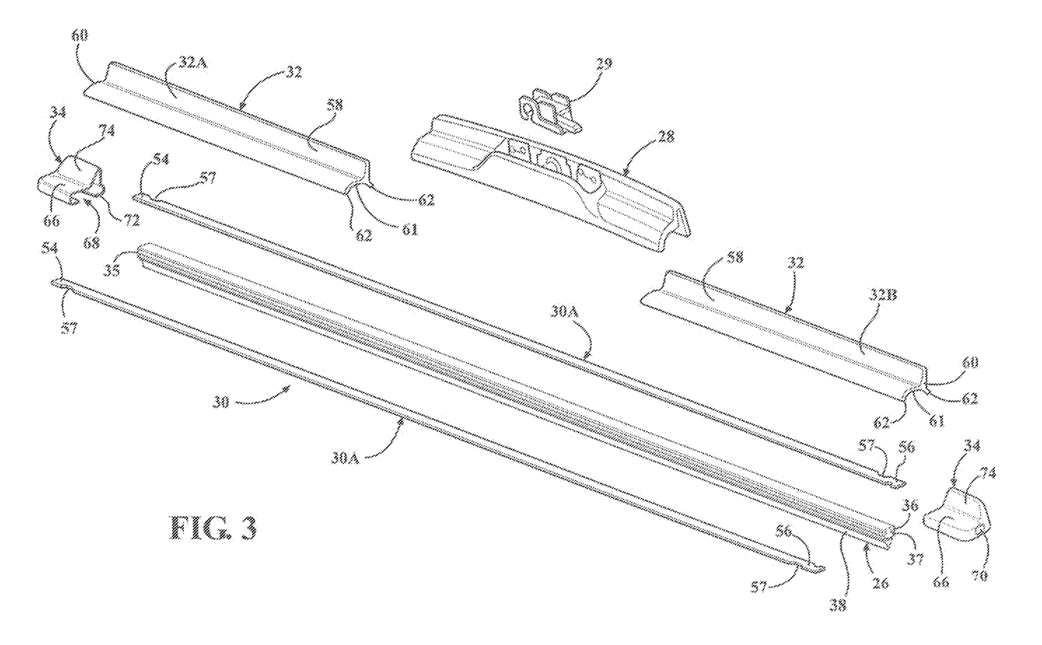

As best shown in FIGS. 2-6, the wiping element 26 includes opposed longitudinal ends 35, 37, an upper section 36 and a lower section 38 that are partitioned by a longitudinally extending bridge portion 40. The bridge portion 40 provides flexibility between the upper section 36 and lower section 38 during operational movement of the wiper assembly 22 across the surface to be wiped. The upper section 36 includes a pair of grooves, generally indicated at 42, extending in the direction of the longitudinal axis of the wiping element 26 (FIG. 3). The grooves 42 are disposed on either side of the wiping element 26 and have laterally extending open ends disposed on opposite sides of the wiping element 26 with respect to each other. The grooves 42 define an upper surface 44 and a lower surface 46. The wiping element 26 includes a predetermined length corresponding to particular application and is often manufactured through an extrusion process, which enables the length of the wiping element 26 to be easily adjusted without a substantial increase to manufacturing expense. Furthermore, while the wiping element 26 of the present invention is constructed from a flexible rubber, those having ordinary skill in the art will appreciate that it may be constructed from any flexible material such as silicone or other polymer without departing from the scope of the present invention.

As noted above, the windshield wiper assembly 22 further includes a pair of splines or rails, generally indicated at 30A. The rails 30A include an upper surface 50 and a lower surface 52 that extend between first and second longitudinal ends 54 and 56, respectively (FIG. 3). Each rail 30A also includes at least one receiving pocket or notch 57 near each of the longitudinal ends 54 and 56 for a function to be described. Each rail 30A is adapted to be received in a snug fashion in a corresponding one of the grooves 42 formed on the upper section 36 of the wiping element 26. Thus, the upper surface 50 of each rail 30A is disposed in abutting contact with the upper surface 44 of the corresponding groove 42. Similarly, the lower surface 52 of the rail 30A is disposed in abutting contact with the lower surface 46 of the corresponding groove 42. The rails 30A may be constructed from a resiliently flexible material, such as spring steel or a polymer, and are adapted to apply force from an intermediate position between the first and second longitudinal ends 54 and 56 to the first and second longitudinal ends 54 and 56. More specifically, the rails 30A receive force from the spring-loaded wiper arm assembly 24 at an intermediate position and distribute this force across the span of the rails 30A toward the first and second longitudinal ends 54 and 56. To that end, the rails 30A may be curved longitudinally with a predetermined radius of curvature. This predetermined radius of curvature is sometimes referred to in the related art as a “free form” radius of curvature. Accordingly, the curvature of the rails 30A may be symmetrical or asymmetrical depending on the force requirements and the contour of the windshield 18. The flexible, free form, pre-curved rails 30A straighten out when the wiper arm assembly 24 applies a force thereto to flatten the rails 30A and directs the wiping element 26 to contact the windshield 18. Thus, the elongated rails 30A include a free-form curvature that ensures force distribution on windshields having various curvatures that effects proper wrapping about the windshield 18.

As illustrated throughout the figures, the rails 30A have a substantially constant width and may have a constant thickness throughout the length between the first and second longitudinal ends 54 and 56. The constant width and thickness are adapted to provide high lateral and torsional stiffness to avoid lateral and torsional deflection, which causes the wiping element 26 to stick/slip (“chatter”) on the windshield 18 during operation. Thus, the cross-section of the rails 30A has a generally rectangular outer profile that makes the elongated rails 30A easier to manufacture. More specifically, where the rails 30A are constructed from metal, such as spring steel, the tools and machinery used to manufacture the rails 30A are less complicated than that required to manufacture rails having varying widths and/or thicknesses. Furthermore, where the rails 30A are constructed from a polymer, such as a thermoplastic elastomer, the tools and extrusion process machinery are also less complicated than those employed to manufacture rails having varying widths and/or thicknesses. However, those having ordinary skill in the art will appreciate that the rails 30A illustrated herein may include a varying thickness and/or width without departing from the scope of the present invention. By way of example, the width and/or thickness of the rails 30A may taper linearly from the beam center, sinusoidally, parabolically, or asymmetrically. Additionally, each rail 30A is illustrated throughout the figures as a single, integral piece of material such that it defines a consolidated cross-section. However, those having ordinary skill in the art will appreciate that the rails 30A may be formed into a single piece by a plurality of laminates.

As noted above and as best shown in FIG. 3, the wiper assembly 22 also includes a coupler assembly, generally indicated at 28. The coupler assembly 28 is adapted to connect the wiper assembly 22 to the wiper arm assembly 24 in any suitable manner commonly known in the art. More specifically, those having ordinary skill in the art will appreciate that the coupler assembly 28 includes structure that corresponds to at least one particular type of wiper arm assembly attachment member, but may include structure that corresponds to multiple types of wiper arm assembly attachment members. By way of example, different OEM's employ wiper arm assemblies having different attachment members adapted to operatively engage a specific beam blade wiper assembly. Accordingly, the coupler assembly 28 illustrated herein includes structure that operatively engages at least one or more of these different attachment members. Further by way of example, certain wiper arm assemblies employed by OEM's include “bayonet-style”; “pin-type”; or “hook-type” attachment members of various sizes that operatively engage the wiper assemblies. Accordingly, the coupler assembly 28 illustrated herein may include an adapter 29 for operatively engaging at least one or more of these different attachment members for use in connection with the wiper assemblies 22 without departing from the scope of the present invention. It should be appreciated that, while a particular coupler is illustrated herein, any suitable coupler assembly 28 may be used to interconnect the wiper arm assembly 24 and the wiping element 26 without departing from the scope of the present invention.

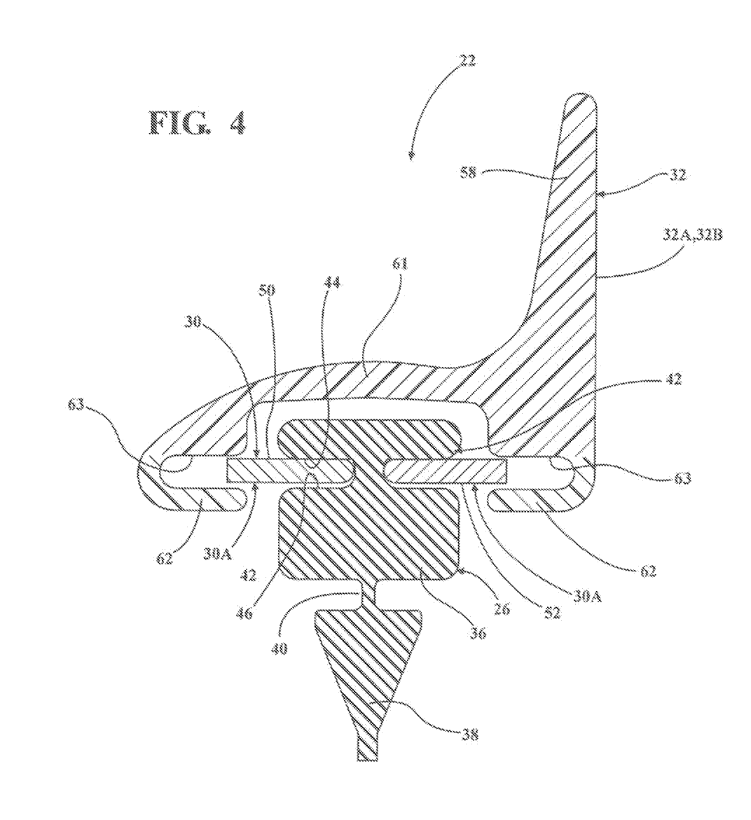

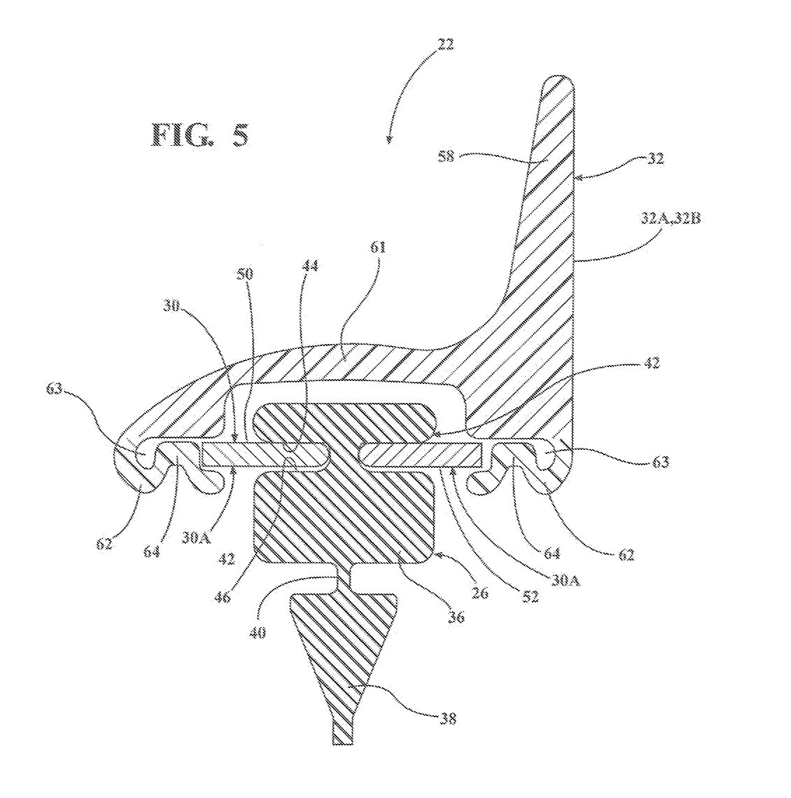

As previously noted, the wiper assembly 22 of the present invention includes the airfoil, generally indicated at 32. The airfoil 32 is operatively mounted to the beam 30, and in the representative example illustrated herein the pair of rails 30A. The airfoil 32 extends between each of the pair of end caps 34. The airfoil 32 acts to reduce the likelihood of wind lift by utilizing airflow to generate downward force on to the wiper assembly 22. More specifically, and in the embodiment illustrated herein, the airfoil 32 includes a pair of airfoil components 32A, 32B that are operatively mounted to the pair of rails 30A and extend between the coupler 28 and each of the pair of end caps 34. However, those having ordinary skill in the art will appreciate that the airfoil 32 may be defined by a single unitary component without departing from the scope of the present invention. Each of the airfoil components 32A, 32B includes a spoiler 58 that tapers inwardly from a base toward a terminal point to define a profile that is slightly contoured (FIG. 4). Each of the airfoil components 32A, 32B includes a distal end 60. Each of the airfoil components 32A, 32B include a body 61 and inwardly extending legs 62 forming grooves 63 between the body 61 and legs 62. The legs 62 may have a durometer harder than a durometer of the body 61 to create a dual durometer airfoil 32. For example, the legs 62 may have a durometer of 50 Shore D and the body 61 may have a durometer of 67 Shore A. In addition, each of the airfoil components 32A, 32B may be manufactured through an extrusion process. However, those having ordinary skill in the art will appreciate that the airfoil 32 may be manufactured using any other conventional means.

As noted above, the wiper assembly 22 of the present invention may include a pair of end caps, generally indicated at 34. The end caps 34 are adapted to be disposed adjacent to the distal ends 60 of the airfoil 32. The end caps 34 include a profile that substantially mimics the contours of the airfoil 32 to maintain the wind lift characteristics of the wiper assembly 22 and to provide an increased aesthetic value. The end caps 34 also provide a mass increase adjacent the distal ends 60 of the airfoil 32 that prevent localized chatter along the extremities of the wiping element 26 caused by the combination of wind lift and a decrease in the force distributed to this area from wiper arm assembly 24 via the rails 30A, as above-described. It should be appreciated that the present invention may be applied to a wiper assembly without end caps.

Referring to FIGS. 4 through 6, a method of assembling the beam blade wiper assembly 22 is shown. As illustrated in FIG. 4, the airfoil 32 includes inwardly extending legs 62 forming grooves 63 to receive the rails 30A. The legs 62 may have a harder durometer than a durometer of the body 61 of the airfoil 32 to create a dual durometer airfoil 32. Each of the rails 30A has a notch 57 or receiving pocket near each end 54,56 thereof. To assemble the beam blade wiper assembly 22, the rails 30A are disposed in the grooves 42 of the wiping element 26. The legs 62 the airfoil 32 are also disposed over the rails 30A such that the rails 30A are disposed in the grooves 63 thereof. The beam blade wiper assembly 22 is now ready for airfoil retention.

As illustrated in FIG. 5, the method utilizes a passive mechanism to provide additional retention of the airfoil 32 to the beam 30 in the event of a potential failure of the end cap 34. The method uses heat staking as a post process for airfoil retention. The method includes heat staking the airfoil components 32A, 32B to the rails 30A by displacing a portion 64 of the legs 62 into the notch 57 of the rails 30A to increase airfoil retention. When the displaced portion 64 of material of the legs 62 is disposed in this manner, the removal of the airfoil components 32A, 32B from the rails 30A is prevented due to the interfering engagement between the displaced portion 64 of material on the legs 62 of the airfoil components 32A, 32B and the notch 57 on the rails 30A. As shown in FIG. 5, the airfoil 32 is retained to the rails 30A after heat staking.

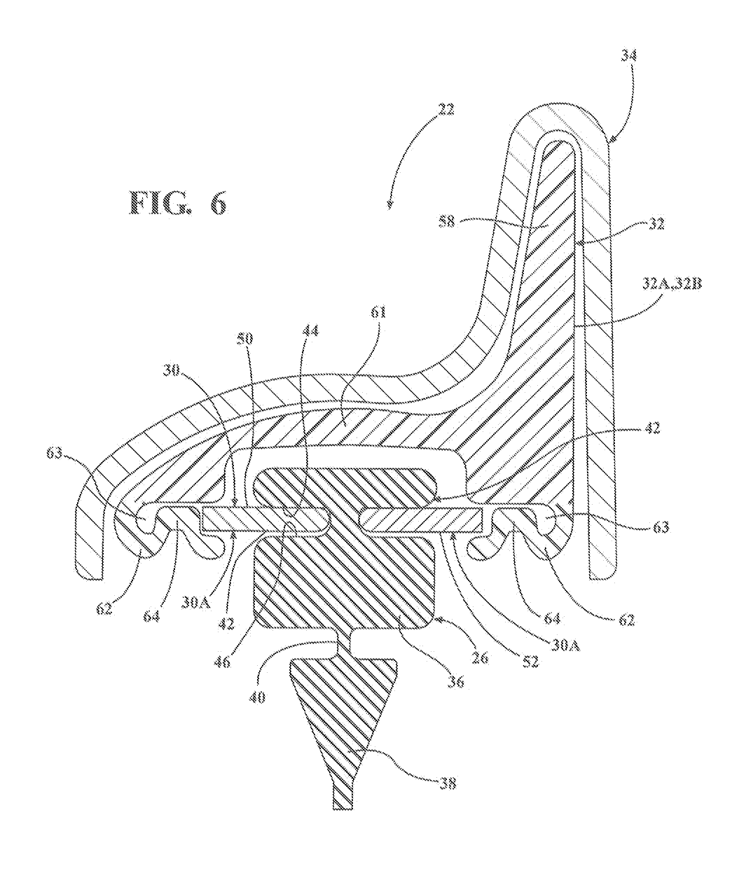

As illustrated in FIG. 6, each of the end caps 34 includes a body 66 having an open end 68 and a closed end 70. In addition, the end caps 34 include inwardly extending legs 72. Together, the body 66 and the inwardly extending legs 72 define a central channel that is adapted to receive the longitudinal ends of the wiping element 26 and the pair of rails 30. The body 66 of the end caps 34 includes a contoured outer surface 74 that substantially corresponds to the contour of the adjacent airfoil component 32A, 32B. As shown, the airfoil 32 is retained to the rails 30 after heat staking and with the end caps 34. It should be appreciated that the heat staking may be performed prior to assembly or in a finished product.

The open ends 68 of the end caps 34 cooperate with the distal ends 60 of the airfoil 32 to further resist inadvertent dislodgement of the end caps 34 from the rails 30. More specifically, the open ends 64 of each end cap 34 are contoured and cooperate with the distal ends 60 of the airfoil 32 to reduce the likelihood that the end caps 34 may be inadvertently removed from the wiper assembly 22. In this way, the cooperation between the open ends 68 of the end caps 34 and the distal ends 60 of the airfoils 32 prevent the end caps 34 from being inadvertently removed or knocked out of engagement with the rails 30 during operation of the wiper assembly 22.

The present invention has been described in an illustrative manner. It is to be understood that the terminology which has been used is intended to be in the nature of words of description rather than of limitation. Many modifications and variations of the present invention are possible in light of the above teachings. Therefore, within the scope of the appended claims, the present invention may be practiced other than as specifically described.

What is claimed is:

1. A beam blade wiper assembly comprising:
a wiping element adapted to contact a surface to be wiped;
at least one elongated beam defining a longitudinal axis, said beam acting to support said wiping element;
an airfoil operatively mounted to said beam;
said beam including at least one notch and said airfoil having a portion displaced into said at least one notch to retain said airfoil to said beam.

2. A beam blade wiper assembly as set forth in claim 1 wherein said notch defines a surface extending substantially transverse to the longitudinal axis of said beam and proximate to the nearest longitudinal end of said beam.

3. A beam blade wiper assembly as set forth in claim 2 wherein said airfoil includes a body and legs extending inwardly from said body.

4. A beam blade wiper assembly as set forth in claim 3 wherein said legs include said portion.

5. A beam blade wiper assembly as set forth in claim 3 wherein said airfoil includes a groove between said legs and said body and extending transverse to the longitudinal axis of said beam, said groove receiving a portion of said beam.

6. A beam blade wiper assembly as set forth in claim 3 wherein said legs have a durometer harder than a durometer of said body.

7. A beam blade wiper assembly as set forth in claim 1 wherein said at least one beam includes a pair of rails having opposed longitudinal ends, each of said rails including said at least one notch disposed proximate said longitudinal ends thereof, each of said notches having an open end facing opposite and outwardly with respect to one another.

8. A beam blade wiper assembly as set forth in claim 7 wherein said airfoil includes a body and legs extending inwardly from said body and each of said legs includes said portion.

9. A beam blade wipe assembly as set forth in claim 1 wherein said wiping element includes an upper section, a lower section, and a bridge extending longitudinally there between, said upper section including a pair of grooves extending in the direction of the longitudinal axis of said wiping element, disposed on either side of the upper section and having laterally extending open ends disposed on opposite sides of the wiping element with respect to each other, each of said rails adapted to be received in snug fashion in a corresponding one of said grooves.

10. A beam blade wiper assembly for a windshield of a vehicle comprising:
a rubber wiping element adapted to contact the windshield, said wiping element including opposed longitudinal ends, an upper section, a lower section, and a bridge extending longitudinally therebetween, said upper section including a pair of grooves extending in the direction of the longitudinal axis of said wiping element, and disposed on either side of the upper section, each of said grooves having laterally extending open ends disposed on opposite sides of said wiping element with respect to each other;
a pair of elongated rails defining a longitudinal axis, each of said rails adapted to be received in snug fashion in a corresponding one of said grooves and acting to support said wiping element, each of said rails including opposed longitudinal ends;
a coupler assembly mounted to said pair of rails between said longitudinal ends thereof, said coupler assembly adapted to interconnect said wiper assembly and a wiper arm that drives the wiper assembly in oscillating fashion across the surface to be wiped;
a pair of airfoil components operatively mourned to said pair of rails, said coupler extending between said airfoil components; and
each of said rails including a notch near each of said longitudinal ends and said airfoil components having a portion displaced into said notch to retain said airfoil to said rails.

11. A beam blade wiper assembly as set forth in claim 10 wherein said airfoil includes a body and inwardly extend legs extending from said body.

12. A beam blade wiper assembly as set forth in claim 11 wherein said legs include said portion.

13. A beam blade wiper assembly as set forth in claim 11 wherein said legs have a durometer harder than a durometer of said body of said airfoil.

14. A method of assembling a beam blade wiper assembly, said method comprising the steps of:
providing a wiping element adapted to contact a surface to be wiped, the wiping element including opposed longitudinal ends;
providing at least one elongated beam defining a longitudinal axis and having at least one notch;
supporting the wiping element with the beam;
providing an airfoil and mounting the airfoil to the beam; and
displacing a portion of the airfoil into the at least one notch to retain the airfoil to the beam.

15. A method as set forth in claim 14 including the step of disposing the beam in grooves of the wiping element and disposing legs of the airfoil over the beam such that the beam is disposed in the grooves of the airfoil.

16. A method as set forth in claim 15 including the step of heat staking the airfoil to the beam by displacing a portion of the legs of the airfoil into the notch of the beam to increase airfoil retention.

17. A method as set forth in claim 16 including the step of creating interfering engagement between the displaced portion of material on the legs of the airfoil and the notch on the beam.
